(19) United States
(12) Patent Application Publication
(10) Pub. No.: US 2002/0138711 A1
(43) Pub. Date: Sep. 26, 2002

(54) Instruction path coprocessor synchronization

(76) Inventors: Adrianus Josephus Bink, Waalwijk (NL); Alexander Augusteijn, Eindhoven (NL); Paul Ferenc Hoogendijk, Eindhoven (NL); Hendrikus Wilhelmus Johannes Van De Wiel, Eindhoven (NL); Wim Feike Dominicus Yedema, Eindhoven (NL)

Correspondence Address: U.S. Philips Corporation, 580 White Plains Road, Tarrytown, NY, 10591, US

(21) Appl. No.: 10/059,443

(22) Filed: Jan. 29, 2002

(30) Foreign Application Priority Data
Jan. 30, 2001 (EP) 01200334.9

(51) Int. Cl. G06F 15/00

(52) U.S. Cl. 712/34

(57) ABSTRACT

An instruction path coprocessor (IPC) (16) observes the value of a CPU program counter (14) of a CPU (10) to detect whether the IPC (16) should be active. The IPC(1 6) uses the value of the CPU program counter also to determine how the IPC should update its own IPC program counter. When a function is called, an exception or interrupt is handled or a jump to a target specified in a register is executed, an address is prepared that, when loaded into the CPU program counter, will cause the IPC to update its IPC program counter as required for the return from function call, exception or interrupt or jump. The prepared address is loaded into the CPU (10) program counter. The program counter (14) return address, for example, contains the virtual machine return address and a bit set to indicate that the address should be treated as a return from the jump to sub-routine

This invention relates to apparatus for synchronizing an instruction path coprocessor and a central processing unit and a method therefor.

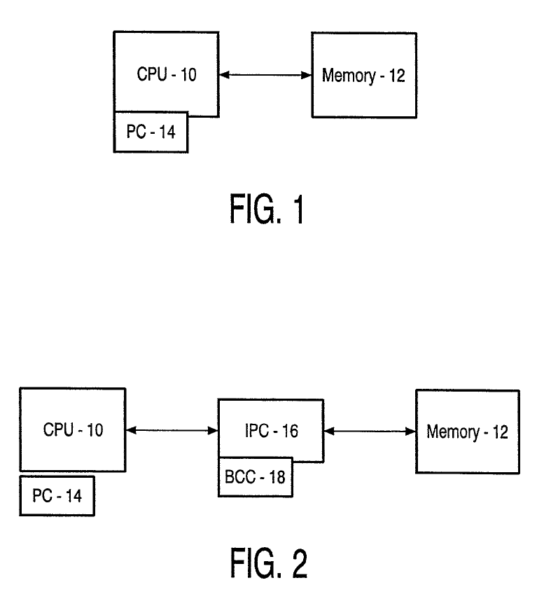

Referring to FIG. 1 a central processing unit (CPU) 10 typically reads and executes instructions stored in a memory 12. A program counter (PC) 14 indicates to the CPU 10 the address of a particular instruction in the memory 12, allowing the CPU 10 to access this instruction and perform the necessary execution thereof.

An instruction path coprocessor (IPC) is used to help a CPU fetch and decode instructions. In FIG. 2 an IPC 16 is located between the memory 12 and the CPU 10 with its program counter 14. The IPC 16 has its own instruction set architecture (ISA) and its own program counter, called a byte code counter (BCC) 18. It is important to note that the IPC 16 may have a different ISA to the CPU 10. If so, and the instructions in the IPC ISA have a different length to those in the CPU ISA, the IPC has to keep track of the current position in a program with the BCC 18. This especially holds if the IPC instructions have variable length and no trivial relation between the PC 14 in the CPU 10 and the program counter 18 of the IPC 16 can be given.

Instructions in an IPC code are processed as follows: the IPC 16 fetches, decodes and translates these instructions into a CPU code instruction set. The IPC instructions are translated into the “native” CPU instruction set and then sent to the CPU 10 for execution.

It is desirable that a minimum of intervention in the CPU 10 is needed to make it cooperate with the IPC 16. Preferably, the IPC should be able to determine its actions from signals that the CPU also needs to issue when it operates without IPC 16.

Generally, a defined “IPC range” of program counter 14 addresses is used to activate the IPC 16. When the CPU 10 tries to fetch an instruction from within the IPC range, the IPC 16 intercepts the fetch instruction and generates an instruction for the CPU 10 from an IPC instruction fetched by the IPC 16 itself.

Normally, the IPC 16 keeps track of the location in the program. But during execution of IPC instructions, responses from the CPU 10 may affect the control flow of the program (dependent on whether there is a sequential flow, or a branch etc.).

U.S. Pat. No. 6,021,265, assigned to ARM Limited, discloses an instruction decoder which is responsive to bits of a program counter register.

Problems arise with the use of instruction path coprocessors as described above in the following situations.

When a CPU 10 receives an interrupt command the CPU 10 starts an execution at a certain interrupt vector, for example the CPU's program counter 14 will be set to that vector to perform the sub-routine or the like requested as a result of the interrupt. It is to be noted that the byte code counter (BCC) 18 of the IPC 10 will not be aware of the cause of the change to the program counter 14. On return from an interrupt the state of the CPU 10, as embodied by the value currently held by the PC 14, will be restored to the value at the time of the interrupt occurring. In this case the state of the IPC 16, specified by the value of the byte code counter 18, will also need to be restored.

When the IPC/CPU combination handles an exception (for example when an unexecutable command is issued, such as division by zero), the CPU 10 will start execution at the appropriate exception vector for that particular exception. As before, the program counter 14 will change value, but the byte code counter 18 of the IPC 16 will not change accordingly. At the return from the exception, the CPU's state will be restored to a state close to that before the exception occurred. It should be borne in mind that the exceptions can be taken in different stages of the CPU pipeline and different restore actions might be necessary. Again, the state of the IPC 16 must also be restored.

When handling function calls, jumps on register and returns from function calls, the following problems are encountered. During sequential execution the IPC 16 only has to detect or be informed that the program counter 14 value is incremented; in which case the IPC 16 can increment its byte code counter 18, making the IPC 16 and CPU 10 synchronized. For conditional branches, the IPC 16 can observe conditional information by passing a CPU branch instruction to the CPU and by detecting whether the CPU branch is taken or not; it can then accordingly handle the branch in the IPC domain. For function calls and jumps to a location specified by the content of a register (“jump on register”) a different mechanism is necessary. For example, a jump on register instruction in the IPC domain may be translated into a jump on register instruction in the CPU domain, the last jump instruction will be executed and the program counter 14 will be set to a CPU register. The IPC 16 can use the CPU program counter address to update its state (e.g. the value of the byte code counter 18) accordingly.

Further problems arise in the handling of non-word-aligned jumps. In the case that the IPC 16 has to jump to a non-word-aligned function, the corresponding jump on the CPU 10 still has to fulfil the alignment restrictions of that CPU.

In other words the problem occurs that the CPU 10 decides to branch to an absolute address in the IPC range (e.g. a branch on register return from function, return from exception etc). Somehow the absolute address determined by the CPU has to be passed to the IPC 16, so that it can set its BCC 18 to that value.

A return can also be viewed as a jump on register, in which a return address is loaded from a register or a stack. Again the byte code counter 18 of the IPC 16 has to be updated in one way or another after a return. When the IPC 16 causes the CPU 10 to call a function of native instructions, the IPC 16 can detect the end of function execution from the fact that the program counter of the CPU 10 reverts back to the IPC range after the return. However, the IPC 16 will need to distinguish whether this is because of the return or because the called function causes execution of some IPC instructions.

It is an object of preferred embodiments of the present invention to provide an instruction path coprocessor which is implicitly synchronized with a corresponding CPU. It is a further object of preferred embodiments of the present invention to address one or more of the above disadvantages.

The apparatus according to the invention is set forth in claim 1. According to the invention, the program counter of the processor (e.g. CPU) is used to pass information that controls the way the IPC program counter is updated, rather than just information about the value to which the IPC program counter is updated. As a result, no communication in addition to the program counter is needed between the processor and the IPC to signal for example return from interrupt, return from exception, jump on register etc.

The information about the way the IPC program counter should be updated is for example contained in one or more bits of the programming unit program counter that the IPC reserves for this purpose. These bits are reserved for example in addition to the bit that is reserved to indicate to the IPC whether the processing unit program counter is in the IPC range or not, that is whether the IPC should provide instructions to the processing unit or not. This is a simple way of encoding the required type of update, which requires little hardware overhead. More generally, the IPC may use a number of predefined program counter address ranges, each associated with its own type of update, the IPC updating the IPC program counter according to the type of update associated with the range in which the processing unit program counter falls.

In the case of interrupt or exceptions, for example, the IPC may be operable to perform the appropriate actions after return from interrupt or exception when the IPC recognizes such a return from the address output by the processing unit program counter. Thus, the IPC needs no signals other than the program counter to decide to respond to interrupts. The actions restore the state of the IPC to a state that corresponds to the state to which the processing unit is restored upon return from the interrupt or exception. The actions may include reloading an “old” IPC program counter value downstream from a pipeline of such values, used for preceding IPC instructions. Dependent on information from the processing unit program counter, the IPC may even make a selection among addresses from different stages of the pipeline to restore the state of the IPC to a state corresponding to the state of the processing unit, when different types of interrupt and/or exception can restore the processing unit to states that are different numbers of cycles back.

Interrupt or exception handling programs preferably modify the address to which they return control after handling the interrupt or exception. This modification is selected so that the return address has a value that causes the IPC to restore its state appropriately.

Similarly, in the case of function calls, for example, the IPC may be operable to respond to a return from a function call when the IPC recognizes such a return from the address output by the processing unit program counter. Thus, the IPC needs no signals other than the program counter to respond to decide to execute the actions needed for a return from function and it does not need overhead to compare different program counter values. When the IPC causes the function to be called, it ensures that the return address provided to the function is an address that, when loaded into the processing unit program counter, will cause the IPC to perform the actions involved with a return from function call.

In the case of jump on register instructions, the IPC needs to obtain a new IPC address from the processing unit. Preferably, information about this address is passed from the processing unit through its program counter. Information in the processing unit program counter signals to the IPC that the IPC needs to obtain a new address from the processing unit program counter. Thus, no additional signals are needed to make the IPC change its address. Preferably, the IPC prepares addresses that may be returned from the processing unit for this purpose, so that these addresses are in a range that will cause the IPC will perform the jump on register.

Often, the processing unit is only capable of producing processing unit program counter addresses that are aligned to certain boundaries in memory (for example addresses in which a certain number of least significant bits is zero). These boundaries will be called “word boundaries” herein. The IPC however may be capable of handling instructions aligned to other boundaries (e.g. boundaries of bytes in a word, or of “nibbles” in a byte or even to bit boundaries). When the IPC obtains the IPC program counter from the processing unit program counter in case of a jump on register IPC instruction, the IPC converts the processing unit program counter address to an address that may be aligned to such other boundaries, for example by shifting part of the bits of the processing unit program counter address to less significant positions. The IPC also performs this action in response to detection that the processing unit program counter address is of a type that requires an update corresponding to a jump on register.

Encoding of the CPU address allows the use of addresses for the IPC which are not necessarily word addresses. Thus the CPU branch is encoded with the address for updating the IPC program counter and for determining the type of address. The invention is particularly advantageous in relation to an IPC that has instructions of variable length with no trivial relation between the CPU program counter and the IPC program counter.

Preferably, the IPC is operable to send an instruction to the CPU to cause the CPU to send a CPU program counter address to the IPC containing the IPC instruction address and instruction type for synchronization of the CPU program counter and the IPC program counter.

By causing the IPC (16) to force the CPU (10) to provide address information and instruction type the IPC (16) can advantageously be implemented in a system without specific implementation costs or modification of the CPU (10).

The instruction may be an absolute branch instruction, such as a branch on register value or a return from interrupt or exception.

The instruction address may be a return address, preferably a return address from an interrupt, an exception, a function call, a jump on register and/or a return to the IPC program counter. The function call may be to a non-word-aligned address. The instruction address may be a word, half-word, byte, nibble, or bit address.

The IPC may be an IPC for decompressing compact code into CPU instructions or an IPC for translating Java byte codes into CPU instructions.

The IPC may have variable length instructions, with no trivial relationship between the CPU program counter and the IPC program counter.

The invention extends to a cell phone, a television set-top box or a hand-held PC incorporating the apparatus of the first aspect.

These and other aspects of the invention will be apparent from and illustrated with reference to the embodiment described hereinafter.

FIG. 1 shows a block diagram of CPU, program counter and memory;

FIG. 2 shows a block diagram of CPU, program counter, instruction path coprocessor and a memory; and

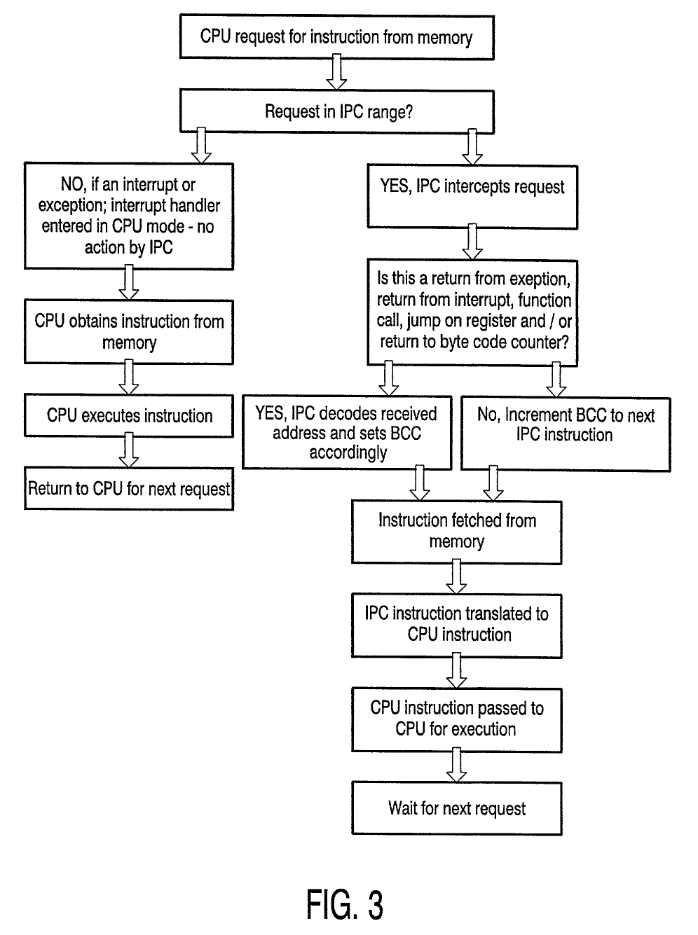

FIG. 3 is a flow diagram showing the sequence of events during operation of an embodiment of the invention.

In the following example, an instruction path coprocessor (IPC) 16 is defined to be active when the program counter 14 of a CPU 10 is in a defined IPC range. When active, i.e. in the IPC range, the IPC 16 intercepts instruction fetches from the CPU 10 and delivers, fetches, decodes, translates IPC instructions into CPU instructions and delivers the CPU instructions to the CPU 10 for execution. For a 32-bit program counter 14 and a 24-bit byte code counter 18 of the IPC 16 the following can be defined:

In_IPC_range(PC)=(PC&0x80000000)==0x80000000

In_RFE_range(PC)=(PC&0xf0000000)==0xf0000000

In_RET_range(PC)=(PC&0xc0000000)==0xc0000000 (The notation of the C-programming language is used. Herein, “&” stands for the bit-wise logical AND operation, “0x . . . ”. stands for a number represented in hexadecimal notation, and “==” stands for a comparison operation that yields a “TRUE” value if the operands to its left and right are equal, and a “FALSE” value otherwise).

In the above RFE stands for return from exception and RET stands for return. Thus, the PC is in the IPC range if its most significant bit is set. The PC is in the RFE range if its four most significant bits are set (“f” is hexadecimal for the binary value 1111). The PC is in the RET range if its two most significant bits are set and the next two less significant bits are zero (“c” is hexadecimal for the binary value 1100).

As shown in FIG. 3, the embodiment is brought in practice as follows.

In this example interrupt vectors are outside the defined IPC range. Also, exception vectors are outside the defined IPC range.

As can be derived from the above the IPC 16 is only active when in_IPC_range(PC).

In this embodiment, interrupts are handled as follows. The CPU 10 acts as normal when the program counter 14 is not in the IPC range (i.e. not(in_IPC_range(PC)). When in the IPC mode (i.e. in_IPC_range(PC)), the interrupt handler will be entered in CPU mode because the interrupt vector is outside the IPC range, as defined above.

Exceptions are handled as follows. The CPU functions normally when the program counter 14 is outside IPC range (i.e. not(in_IPC_range(PC)). When in the IPC mode (in_IPC_range(PC)), the exception handler will be entered in CPU mode, because the exception vector is outside the IPC range, as defined above.

Returns from exception (or interrupt) are handled as follows (for a return address PC′). The CPU functions ordinarily for a return to CPU mode when the return address PC′ is not in the IPC range (i.e. not(in_IPC_range(PC′)). For a return to IPC mode (when the return address PC′ is in the IPC range: in_IPC_range(PC′)), the exception/interrupt handler will change the return address (PC′) by performing an “OR” operation of the return address (PC′) with 0×c00000, so that in_RFE_range(PC′) will hold upon execution of the return. The IPC 16 will detect this return from the exception and will restart execution from a restored state.

Restoration of the state involves for example reloading IPC program counter with an value that has been used as IPC program counter a predetermined number of instruction cycles before the interrupt or exception occurred. Preferably, the IPC contains a pipeline of registers, through which such IPC program counter values are shifted each time a new processing unit instruction cycle is started (if needed this pipeline may shift other state information in addition to the program counter values). Upon return from interrupt or exception the IPC program counter value (and, if needed, other state information) is restored to the value contained in the pipeline stage that corresponds to the processing cycle to whose the state of the processing unit (CPU) is restored.

Function calls (to possibly non-word-aligned addresses), and returns to byte code counter 18 of the IPC 16 are handled as follows. The IPC passes a return address PC′ to the CPU for which in_RET_range(PC′) holds by setting PC′ to 0xc000000|(BCC<<2) (“|” stands for a bit-wise logical OR and “BCC<<2” represents shifting the bits of BCC by two bits to more significant bit positions). This address PC′ is word-aligned (i.e. its two least significant bits are zero), so the CPU 10 will have no problem using the address. When the CPU performs a return operation, which causes the return address PC′ to be loaded into the CPU program counter, the IPC 16 will detect in_RET_range(PC), and it will reconstruct/set its byte code counter 18 from the program counter 16 by taking the lower 26 bits and shifting it to the right by 2.

A similar procedure is followed in case of a jump instruction that jumps to a target IPC program counter address that has to be retrieved from a CPU register (or from memory). The IPC store a value PC′=(JOR|(TARGET<<2)) in the register or memory (JOR stands for a bit pattern that identifies a jump on register, for example 0xd0000000, or 0xc000000 if the same actions are needed as in case of a return from function call, TARGET stands for the target value for BCC). This address PC′ is word-aligned (i.e. its two least significant bits are zero), so the CPU 10 will have no problem using the address. When the CPU performs a native jump on register, which causes the return address PC′ to be loaded into the CPU program counter from the register or the memory, the IPC 16 will detect, the “JOR” bit pattern and it will set its byte code counter 18 from the program counter 16 by taking the lower 26 bits and shifting it to the right by 2.

Update of the byte code counter (BCC) 18 based upon the restored state or from the program counter 14 can take place for example under the following conditions:

calls from CPU range to IPC domain functions

in returns from interrupt/exception

return from a function in CPU domain to the caller in the IPC domain.

function calls/absolAte jumps from the IPC domain to IPC domain

return from IPC domain to IPC domain.

An example of a function call and return sequence is as follows:

| PC | BCC | IPC INSTRUCTION | GENERATED CPU INSTRUCTION |
|---|---|---|---|
| 0x8000044 | 0X000004 | link to BCC 0x6 | MRC link, 0xc0000018 |
| 0x8000044 | 0x000005 | call to BCC 0x17 | MOV PC, 0xc000005c |
| 0x8000048 | 0x000006 | IPC_sub | not relevant (branch delay slot) |
| 0x800004c | 0x000007 | IPC_st | not relevant (branch delay slot) |
| 0xc00005c | 0x000017 | IPC_add | ADD |
| 0xc000060 | 0x000019 | IPC_return | MOV PC, link |
| 0xc000064 | 0x000020 | IPC_nop | not relevant (branch delay slot) |
| 0xc00005c | 0x000021 | IPC_nop | not relevant branch delay slot) |
| 0xc000018 | 0x000006 | IPC_sub | SUB |

With the “call” instruction a function is called. With the “link to BCC” instruction, a return address is loaded into a CPU register. After execution, the function will make the CPU return control to the return address specified in the link to BCC instruction.

The most significant bits of the return address have the hexadecimal value “c” (=1100), so that it is in the RET range. The less significant bits have the hexadecimal value “18”, which is equal to 6<<2, i.e. the IPC program counter address of the IPC instruction that follows the call instruction.

The call instruction causes the CPU to update its program counter to the address 0xc000005c. Once loaded into the CPU program counter, this address indicates to the IPC that it should load its IPC program counter from the CPU program counter (because the most significant bits are equal to hexadecimal “c”). The CPU program counter also indicates that the new IPC program counter value BCC is hexadecimal 17 (obtained by shifting the less significant bits of the CPU program counter (hexadecimal 5c) two bits to the right). The IPC computes this new program counter value BCC from the CPU program counter.

After executing the function (to avoid too many instructions that are superfluous for the invention, the function contains only an ADD instruction in the example), a MOV instruction causes the CPU to move the return address 0xc0000018 into the CPU program counter. This causes the IPC to restore its address to 0x 00000006, after which instructions following the original function call are executed.

In the example, all CPU instructions are generated by the IPC in response to IPC instructions. The invention is not limited to this situation: without deviating from the invention the IPC may also cause the CPU to call a function outside the IPC range, to execute native instructions from memory. These instructions in turn could jump back to IPC instructions by loading the return address, or the instructions could jump back and forth between IPC instructions and native instructions before loading the return address.

The embodiment described above may be put into practice by use with the IPC known as a ThumbScrews Decoder (TSD) which converts the compact ThumbScrews instruction set to ARM code. The ThumbScrews Decoder can be used in products like a GSM cell phone, a set-top box for a television and hand-held personal computers, which contain megabytes of embedded software. With code compaction techniques (and a corresponding decoder), it is possible to reduce the required memory size and cost of the apparatus when compared to currently leading processors like ARM Thumb.

In addition, the described techniques can be used for example in the so-called VMI (Virtual Machine Interface), which is an IPC that translates Java byte code to code for a MIPS processor.

The above described embodiment discloses an instruction path coprocessor synchronization mechanism which can be used for synchronization with a processing unit in the case of function calls, exceptions, return from interrupt etc. The synchronization of the instruction path coprocessor and the CPU is implicit by the instructions generated for the program counter of the CPU.

The IPC 16 observes the value of the program counter 14 of the CPU 10 to detect whether the IPC 16 should be active. If the PC 14 is in a predetermined range, the IPC 16 should be active. The IPC 16 further uses the PC 14 to detect which sub-routine is called. The described embodiment uses the PC 14 also for detecting the return address upon return from sub-routine (or return from interrupt etc). When a function is called, the IPC 16 prepares a specially prepared PC return address and loads it into the processor stack. The PC return address contains the virtual machine return address and a bit set to indicate that there is a return from the jump to sub-routine. The IPC 16 uses the return address to resume processing when the PC return address is restored.

Synchronization is achieved by the returning program modifying the return address to enable the IPC to detect the return and distinguish the return from execution of IPC machine instructions and native instructions.

Thus, the described embodiment has the significant advantage of providing an instruction path coprocessor which is synchronized with its CPU.

1. Apparatus in which a processing unit (CPU) (10) is synchronized with an instruction path coprocessor (IPC) (16) comprises a processing unit (10) having a processing unit program counter (14) and an IPC 16 having an IPC program counter (18), characterized in that
the IPC (16) is operable to decode an instruction address received from the processing unit program counter (14), to select a required type of update of the IPC program counter (18) under control of the instruction address received from the processing unit program counter (14), and to update the IPC program counter (18) according to the selected type;
the IPC (16) also being operable to fetch the instruction addressed by the IPC program counter, to decode the instruction and pass it to the processing unit (10) for execution.

2. Apparatus as claimedin claim 1, wherein the IPC (16) is arranged to select the required type of update from a set of types that includes at least two of the following types of update, under control of the instruction address received from the processing unit program counter (14):
(a) retrieving the IPC program counter value from IPC program counter values of IPC instructions in a pipeline of IPC instructions in various stages of execution;
(b) determining the IPC program counter value from a value contained in the instruction address received from the processing unit;
(c) changing the IPC program counter value according to normal IPC program flow.

3. Apparatus as claimedin claim 2, the IPC selecting from the set under control of a predetermined bit from the processing unit program counter.

4. Apparatus as claimedin claim 1, the IPC being operable, in response to receiving an instruction address value in a predetermined range, to retrieve the IPC program counter value from IPC program counter values of IPC instructions in a pipeline of IPC instructions in various stages of execution;
the apparatus being programmed with an interrupt and/or exception handler program that is arranged to perform a modification of a return address for returning from an interrupt and/or exception before returning normal program control, the modification altering the return address to a value in said predetermined range.

5. Apparatus as claimedin claim 1, the IPC being operable, in response to receiving an instruction address value in a predetermined range, to execute a return from function call operation;
wherein the IPC is operable to store a function return address before transferring control to a function, the IPC selecting the function return address in the predetermined range.

6. Apparatus as claimedin claim 1, the IPC being operable, in response to receiving an instruction address value in a predetermined range, to execute a IPC program jump to a target location with an address determined from the processing unit program counter;
wherein the IPC is operable to
cause the processor unit to store a target value from the predetermined range in a storage location, the target value identifying the target location;
cause the processor unit to execute a program counter changing instruction in which the program counter is loaded from the storage location.

7. Apparatus as claimed in claim 6, in which the instruction address value is word aligned, the IPC determining the address of the target location in such a way that a non-word-aligned value of the address of the target location is possible.

8. Apparatus as claimed in claim 7, the determining of the address of the target location comprising shifting at least part of bits of the instruction address value to bit positions that sub-word aligned locations.

9. Apparatus as claimed claim 1, in which the IPC (14) has variable length instructions.

10. A cell phone, television set top box or hand held PC including the apparatus according to any one of the preceding claims.

11. A method of synchronizing a central processing unit (CPU) (10) with an instruction path coprocessor (IPC) (16) is characterized in that the method comprises:
causing the IPC (16) to decode an instruction address received from a processing unit program counter (14) of the processing unit (10) to thereby enable the IPC (16) to determine the instruction address;
determining the type of instruction address received;
updating an IPC program counter (18) of the IPC (16) in way dependent on the type of instruction address;
fetching the instruction;
decoding the instruction; and
passing the instruction to the processing unit (10) for execution.

12. A method as claimed in claim 11, in which prior to decoding the instruction address received from the processing unit (10), the IPC (16) sends an instruction to the processing unit (10) to cause the processing unit (10) to load an address in to the processing unit program counter that contains both instruction address and instruction type information.
